(19) United States
(12) Patent Application Publication
(10) Pub. No.: US 2020/0193503 A1
(43) Pub. Date: Jun. 18, 2020

(54) METHOD AND DEVICE FOR COMPUTER-SUPPORTED HAIR TREATMENT CONSULTATION

(71) Applicant: Henkel AG & Co. KGaA, Duesseldorf (DE)

(72) Inventors: CARSTEN MATHIASZYK, Essen (DE); TORSTEN LECHNER, Langenfeld (DE)

(73) Assignee: Henkel AG & Co. KGaA, Duesseldorf (DE)

(21) Appl. No.: 16/638,947

(22) PCT Filed: Aug. 14, 2018
(86) PCT No.: PCT/EP2018/072059

§ 371 Date: Feb. 13, 2020

(30) Foreign Application Priority Data
Aug. 16, 2017 (DE) 10 2017 214 251.0

(51) Int. Cl. G06Q 30/06; G06N 5/04; G06T 7/90; A45D 44/00

(52) U.S. Cl. CPC G06Q 30/0631; G06N 5/04; G06Q 30/0633; G06Q 30/0639; A45D 2044/007; G06T 7/90; A45D 44/005; G06T 2207/30201; G06T 2207/10024; G06Q 30/0623

(57) ABSTRACT

In various exemplary embodiments a method for computer-aided hair treatment consultation is provided. The method may include determining an original hair condition of a user, the original hair condition comprising an original hair color of the user, determining a skin color of the user, determining a plurality of hair coloring results based on the original hair condition of the user and a plurality of hair colorant compositions, determining at least one skin color associated hair coloring result based on the plurality of hair coloring results and the skin color of the user, and displaying the at least one skin color associated hair coloring result.

### CROSS-REFERENCE TO RELATED APPLICATION

This application is a U.S. National-Stage entry under 35 U.S.C. § 371 based on International Application No. PCT/EP2018/072059, filed Aug. 14, 2018, which was published under PCT Article 21(2) and which claims priority to German Application No. 10 2017 214 251.0, filed Aug. 16, 2017, which are all hereby incorporated in their entirety by reference.

### TECHNICAL FIELD

The present disclosure concerns a method and an apparatus for computer-aided hair treatment consultation.

### BACKGROUND

Although users can use applications (apps) of their so-called “smart devices” (e.g. smartphones, phablets or tablets) to visualize new possible hair dyes (colorations) and/or hairstyles, they can usually only do so in a very simple form with not all available shades of coloration.

Often, no original hair colors can be detected and/or the user's current hair color cannot be entered.

Furthermore, no recommendations for colorations that match the (face) skin color (complexion) can be provided.

Furthermore, no hairstyles can be recommended that would match the shape of the head.

Furthermore, it is possible that hair damage is not taken into account when recommending a coloration.

### SUMMARY

This disclosure provides a method for computer-aided hair treatment consultation, wherein the method includes:

providing at least one digital image of a user in which both hair and skin of the user are shown;

determining an original hair condition of a user, wherein the original hair condition comprises an original hair color of the user;

determining a skin color of the user;

determining a plurality of hair coloring results based on the original hair condition of the user and a plurality of hair colorant compositions;

determining at least one hair coloring result associated with the skin color based on the plurality of hair coloring results and the skin color of the user; and

output of at least one hair coloring result assigned to the skin color.

This disclosure also provides a method for computer-aided hair treatment consultation, wherein the method includes:

providing at least one digital photograph of a user in which both hair and skin of the user are depicted;

determining an original hair condition, wherein the original hair condition comprises an initial hairstyle;

determining a facial shape of the user;

determining at least one hairstyle result based on the original hairstyle and the facial shape of the user; and

output of at least one hairstyle result.

This disclosure further provides a data processing device for carrying out a method for computer-aided hair treatment consultation, wherein the data processing device is configured to perform the aforementioned method.

### BRIEF DESCRIPTION OF THE DRAWINGS

The present disclosure will hereinafter be described in conjunction with the following drawing figures, wherein like numerals denote like elements, and:

FIG. 1 a flowchart showing a method for computer-aided hair treatment counseling according to various exemplary embodiments;

FIG. 2 a schematic representation of a data processing device according to various exemplary embodiments;

FIGS. 3A and 3B each an illustration of a method for computer-aided hair treatment consultation according to various exemplary embodiments;

FIG. 4 a flowchart showing a method for computer-aided hair treatment consultation according to various exemplary embodiments; and

FIGS. 5A, 5B and 5C each an illustration of a method for computer-aided hair treatment counseling according to various exemplary embodiments.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

In the following detailed description, reference is made to the attached drawings, which form part of the present application and which, for illustration purposes, show specific embodiments in which the instant disclosure can be implemented. It is understood that other embodiments can be used and structural or logical modifications can be made without deviating from the scope of protection of the instant disclosure. It is understood that the features of the various exemplary embodiments described herein may be combined with each other unless specifically stated otherwise. The following detailed description is therefore not to be understood in a restrictive sense and the scope of protection of the instant disclosure is defined by the claims attached.

In various exemplary embodiments a procedure is provided, for example using an app, which can help more specifically to find a suitable hair coloration with the right color shade.

In various exemplary embodiments, a photo can be provided by employing the application (e.g. app, e.g. for smart devices), e.g. taken from a media library, or taken directly with a digital camera, e.g. the smart device.

The software (app) can be set up in various exemplary embodiments to recognize the hair shown in the photo and to determine a current hair color and (facial) skin color by employing an automatic and/or manual white balance (if necessary using a color card).

In various exemplary embodiments, a user may specify whether he or she has hair that has been never been dyed up to now or whether the hair has already been dyed.

To specify an existing hair color shade achieved by employing a hair coloring, a number of typical shades and/or exact shades of hair color series can be provided for selection by the user.

In addition, in various exemplary embodiments, it is possible to specify when the last hair coloration took place and/or how high a percentage of gray is in the hair.

In various exemplary embodiments information about further/other treatments such as permanent wave, use of hair straightener and/or hair treatment products can be provided.

After providing the photo, the application (app) can be used to suggest an achievable hair color shade based on the original hair color and/or the facial skin color. In various exemplary embodiments, the proposed hair color shade can be visualized directly as a 2D and/or 3D image. A 3D visualization is possible, for example, if the user's head has been photographed in advance from different positions.

Furthermore, a color shade can be specified in various exemplary embodiments and/or a specific color shade of a hair coloring series can be selected. This can then also be shown to the user on the screen. Furthermore, information about hair color products which are no longer available can be provided. The application can be used to provide one or more alternatives with similar coloring results in various exemplary embodiments.

In a case where a predicted coloring result is not yet completely to the user's liking, an option to make a slight color adjustment can be provided. This can be adjusted in various exemplary embodiments by one or more sliders (e.g. by wiping, a slider control, a joystick, a mouse, a keyboard or similar) in different directions (e.g. light-dark, blue-yellow, green-red). Subsequently, a hair dye product can be provided (e.g. shown) to a user, which provides a predicted hair coloring result with the smallest color difference (of all available hair dye products) to the selected dye result.

In various exemplary embodiments an option can be provided to order a hair dye selected in this way directly online, e.g. by employing the smart device. Alternatively or additionally, an option can be provided to provide the user with information about where the product is available.

In various exemplary embodiments the apparatus can be set up to facilitate the selection of a new hairstyle. In various exemplary embodiments the application (app) can be set up to recognize a face shape and can provide hairstyles that match the determined face shape.

In various exemplary embodiments, however, other hairstyles can also be selected without restriction.

In various exemplary embodiments a hairstyle can be selected by employing a second image, e.g. from a media library, and/or a photo can be taken showing a desired hairstyle, which can be recognized by the software (e.g. app), so that comparable hairstyles can be provided from the application.

After selecting a desired hairstyle, the user can be provided with information on how to achieve this result or which hair treatment products are required to achieve the desired hairstyle. In various exemplary embodiments these can then be ordered directly online using the smart device. Alternatively or additionally, the user can be provided with information about where the products are available.

In various exemplary embodiments, a simpler and more effective way of selecting a new hair color shade can be provided.

Hair colorants can contain a mixture of different dye precursors and can therefore also be called dye mixture or dye composition.

In various exemplary embodiments, methods from the field of predictive analytics (also known as “Big Data”, “Data Mining” or “Machine Learning”), are used to enable precise calculations of properties of hair colors, e.g. a color parameterized in a color space, despite the fact that there may be many unknowns in a coloring mixture.

In this context, a “color” may be defined as a combination of a color shade (i.e. a spectral color impression, also known as hue, which can be understood as what is considered the “actual color”), a color intensity (i.e. how intense the color appears, e.g. compared to a neutral gray, which is also referred to as saturation, hue, chromaticity, chromacity or color depth) and a brightness (i.e. how light or dark the color appears).

In various exemplary embodiments, the color information can be parameterized in a known color space, for example in an L*a*b* color space (where L* indicates the brightness of a color, a* the green and red components and b* the blue and yellow components of the color; sometimes Lab (or individually L, a, or b is also used herein as a shortening notation) in an RGB color space by color components in red, green and blue, in a CMYK color space by color components in cyan, magenta, yellow and black, or in any other color space.

In this context, the term “hue”, as described above, may be understood to mean the spectral color impression of a color, regardless of how it may be parameterized, for example as a point in a two-dimensional color space (e.g. a*b* of the L*a*b* system) or a ratio of color components (as in the RGB color space or the CMYK color space).

In various exemplary embodiments, a color space, to which the color information (e.g. the hair color information of the dyed hair or of the hair before coloring, which is also referred to as basic hair color or original hair color), or in which the color information is represented (e.g. when a hair color is represented, see below) can be such that a determined or represented color is independent of a medium by which the color is determined or represented (e.g. color measuring device, screen, printer, scanner, human eye, etc.). The color space can be, for example, an L*a*b* color space, the color information a color shade parameterized by employing a* and b*, for example. The uniform representation in the medium-independent color space can, for example, allow it to present a realistic coloring result that can be expected, for example, in that a color obtained by dyeing leaves the same color impression on the observer of the dyed hair as in a representation of the expected result, for example as a package imprint, a display on a computer screen, or similar.

In various exemplary embodiments, a predictive analytic model can be used which, given an original hair condition (which forms independent variables for using the model and may include, for example, the original hair color, a degree of hair damage, a grey content, etc.), determines an expected coloring result for a plurality of hair colorant compositions.

In various exemplary embodiments, the model may have been generated by employing predictive analytics using test hair dyes as a continuous model, i.e. in such a way that a prediction of a dyeing result is possible not only for combinations of original hair conditions and hair colorant compositions used experimentally in combination, but also for other, not experimentally determined combinations of original hair conditions and hair colorant compositions.

In various exemplary embodiments the described method for computer-aided prediction of hair color properties can be carried out by employing a data processing device.

The data processing device may for example comprise a computer, or any other data processing device which is suitable to store and provide the data and to carry out the predictive analytics method, for example any data processing device with a sufficiently large data memory and a sufficiently powerful processor. The data processing device may in various exemplary embodiments comprise a smartphone, tablet, iPad or the like.

In various exemplary embodiments, the data processing device may comprise at least one input device for inputting information into the data processing device, for example for inputting information concerning the user, e.g. when he last dyed his hair and with what, etc., and optionally for inputting instructions, parameters, etc. for carrying out the method.

In various exemplary embodiments, the data processing device may include at least one output device for outputting information, for example for outputting results of the method.

In various exemplary embodiments, the at least one output device may have a monitor and/or a printer and/or a loudspeaker.

In various exemplary embodiments, for example, if the coloring result parameters to be output include a hair color, the color can also be parameterized for output in a medium-independent color space, for example the L*a*b* color space. This makes it possible, for example, to ensure that the expected coloring result determined as described above, which can be printed out (for example, on a package of a dye product), appears essentially as it would appear in reality after dyeing. If the output device requires a different parameterization of the color, the determined color can be transformed from one color space to another.

In various exemplary embodiments a method for computer-aided hair treatment consultation is provided. The method may comprise determining an original hair condition of a user, the original hair condition comprising an original hair color of the user, determining a skin color of the user, determining a plurality of hair coloring results based on the original hair condition of the user and a plurality of hair coloring compositions, a determination of at least one hair coloring result associated with skin color based on the plurality of hair coloring results and the skin color of the user, and an output (in particular a representation) of the at least one hair coloring result associated with the skin color.

In various exemplary embodiments, determining hair color and determining skin color may include providing a digital image of the user.

In various exemplary embodiments, the determination of the hair color and the determination of the skin color may involve the capture of a digital image of the user.

In various exemplary embodiments, a single digital image may be used, in which both the hair and skin of the user are represented.

In various exemplary embodiments, the skin color of the user may be determined based on a facial skin of the user.

In various exemplary embodiments different digital images may be provided, whereby in at least one of the digital images the user's hair is depicted, and in at least one other of the digital images a facial skin of the user is depicted.

In various exemplary embodiments, the original hair condition may also show a degree of hair damage and/or a degree of graying.

In various exemplary embodiments, the determination of a plurality of hair coloring results based on the original hair condition of the user and a plurality of hair colorant compositions can be performed by employing predictive analysis.

In various exemplary embodiments, the determination of at least one hair coloring result assigned to the skin color can be carried out using an assignment rule obtained by employing empirical studies.

In various exemplary embodiments, the method may further comprise modifying the hair coloring result by the user to a desired hair color and determining the hair colorant composition from the plurality of available hair colorant compositions which has the smallest color difference from the desired hair color.

In various exemplary embodiments the available hair colorant compositions may be the commercially available hair colorant compositions.

In various exemplary embodiments a method for computer-aided hair treatment consultation is provided. The method may comprise determining an original hair condition, wherein the original hair condition comprises an original hairstyle, and determining a facial shape of the user, determining at least one hair styling result based on the original hairstyle and the facial shape of the user, and outputting (in particular a representation) the at least one hair styling result.

In various exemplary embodiments, the method may further comprise the following step: providing at least one digital image of a user in which both hair and skin of the user are depicted.

In various exemplary embodiments, the determination of the original hair condition may include the provision of a digital image of the user, which depicts his head approximately from the front.

In various exemplary embodiments the determined hairstyle result may show at least one of a plurality of hairstyles that can be achieved by reshaping the hair.

In various exemplary embodiments, the determined at least one hairstyle result may include one of a plurality of hairstyles that can be achieved by reshaping and/or shortening the hair.

In various exemplary embodiments the hairstyle result may be displayed in the desired hair color or the determined hair coloring result.

In various exemplary embodiments, the method may further include the provision of a desired hairstyle by the user, the determination of a hairstyle most similar to the desired hairstyle from a plurality of achievable hairstyles and display the most similar hairstyle in the hair color of the assigned hair coloring result.

In various exemplary embodiments, the method may further include the provision of product and/or hair treatment information based on the determined hair coloring result and/or on the determined hairstyle result.

In various exemplary embodiments a data processing device is provided for carrying out a method for computer-aided hair treatment consultation, wherein the data processing device may be designed to carry out the method according to one of the preceding claims.

In various exemplary embodiments, the data processing device may include a processor, wherein the processor may be configured to perform the determination of the relationship.

In this context, the terms predictive analytics, big data and data mining are used synonymously.

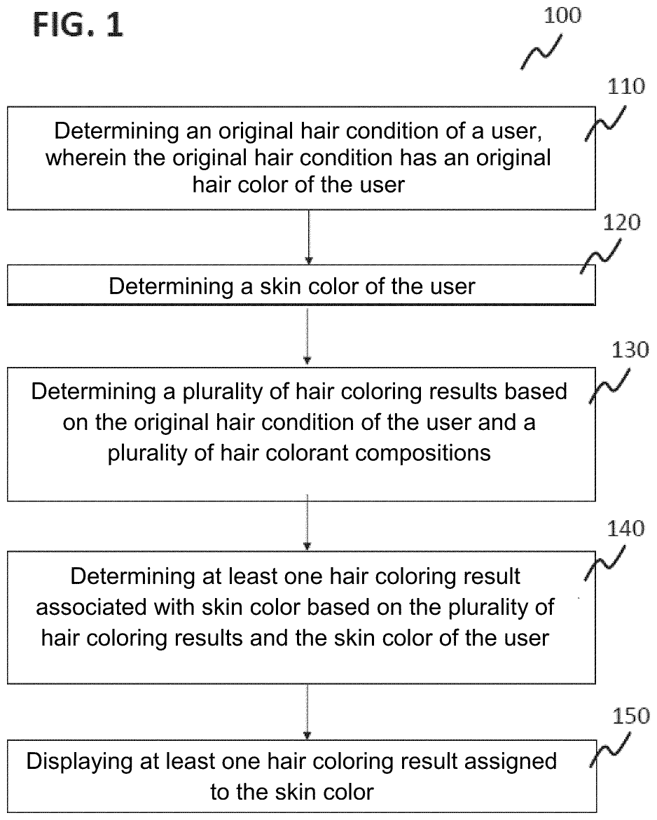

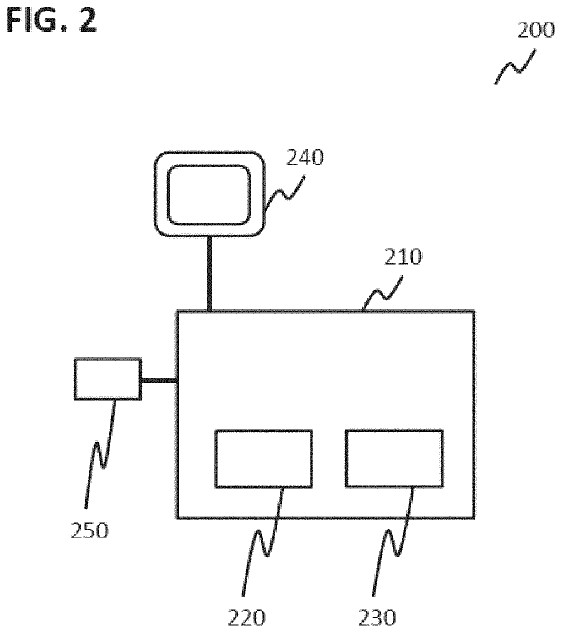

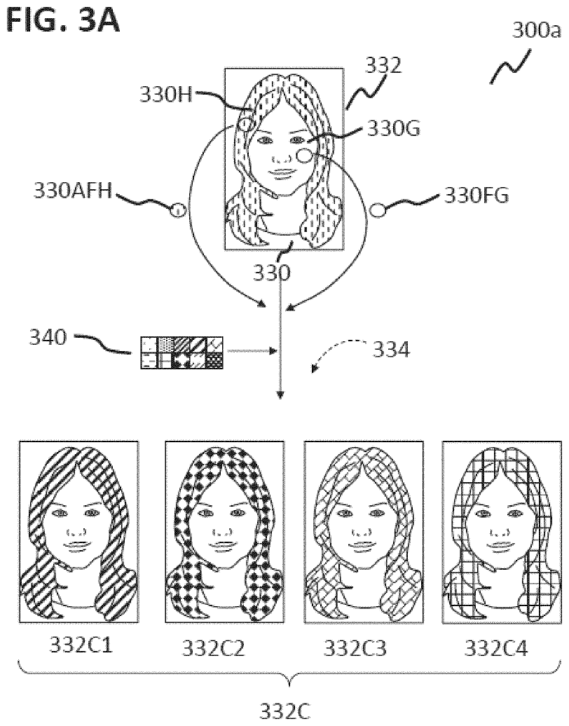

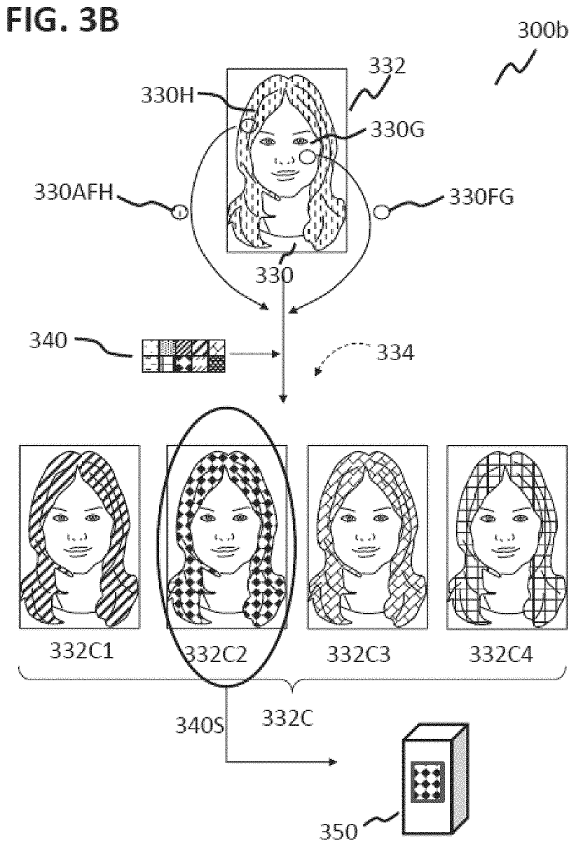

FIG. 1 shows a flowchart 100 illustrating a method for computer-aided hair treatment counseling according to various exemplary embodiments, FIG. 2 shows a schematic representation of a data processing device 200 according to various exemplary embodiments, and FIG. 3A and 3B each show an illustration 300a and 300b of a method for computer-aided hair treatment counseling according to various exemplary embodiments.

The method can be executed in various exemplary embodiments by employing the data processing device 200, for example by employing software installed on the data processing device 200, e.g. an application (app).

The data processing device 200 can be or comprise, for example, a smartphone, a tablet, an iPad, a PC, a laptop or any other data processing device 200 which is suitable for carrying out the method of computer-aided hair color consulting, for example, has a sufficiently large memory and a sufficiently powerful processor.

The data processing device 200 may comprise in various exemplary embodiments a data processing unit 210 with a processor 220. The processor 220 may, for example, be a microprocessor of the data processing unit 210, or the data processing unit 210 may include such a microprocessor.

In various exemplary embodiments, the data processing device 200 may include a data storage device 230. The data storage device may be an internal or external data memory 230 of one of said data processing device 200 or may have such a data memory 230. The data storage device 230 may be designed to store data which is stored and/or retrieved when carrying out the method for computer-aided hair color consulting, for example a mapping rule, a predictive analytic model for determining hair coloring results, hair colorant compositions, etc.

In various exemplary embodiments, the data processing device 200 may include a display device 240. For example, display device 240 may include a screen of a PC, laptop, or any other data processing device 200. The display device may be used, for example, to display results of the method for computer-aided determination of properties of hair colors, to request input parameters for the execution of the method, or the like.

In various exemplary embodiments, the data processing device 200 may include an input device 250 for providing information for the data processing device 200, for example a keyboard, a mouse, a microphone, a touch-sensitive surface of the display device 240, or the like.

In various exemplary embodiments a digital photograph 332 on which a user 330 is represented may be provided as shown in FIG. 3A and FIG. 3B. In particular, the photograph may show hair of user 330. Furthermore, the photograph 332 may show skin of user 330. Alternatively or additionally, a plurality of photographs 332 may be provided in various exemplary embodiments, whereby the hair may be depicted in at least one of the photographs 332, and the skin may be depicted in at least one of the photographs 332.

The at least one digital photograph 332 may be taken in various exemplary embodiments using a digital camera. This can be an archived photograph 332 of user 330, which may be loaded, for example, from a data memory and/or transferred to the data processing device 200, or it may be a photograph 332 taken specifically for carrying out the method. The digital photograph 332 may also be part of a video sequence. In various exemplary embodiments, the digital photograph 332 may be a conventional digitized photograph 332 provided for the data processing device 200.

In various exemplary embodiments an original hair condition of the user may be determined, whereby the original hair condition (as an original hair condition parameter) may have an original hair color 330AFH of user 330 (in 110).

In various exemplary embodiments the original hair color 330AFH may be determined on the basis of the provided photograph 332.

The determination of the original hair color 330AFH of user 330 in the provided photograph 332 may be carried out in various exemplary embodiments in an essentially known manner, e.g. by identifying a hair area 330H in the photograph and determining a hair color 330AFH (e.g. as an average value of hair colors encountered in the hair area) or an area of hair colors 330AFH (e.g. an area, which includes those hair colors which are most frequently present in the hair area).

In various exemplary embodiments, the original hair condition, which may have an influence on a dyeing result, may show, in addition to the original hair color, a degree of damage to the hair and/or a degree of graying of the hair and possibly further original hair condition parameters. The optionally provided further original hair condition parameters are marked with 334 in FIG. 3A and FIG. 3B.

In various exemplary embodiments, the additional original hair condition parameters can be made available to the method, for example as input by the user and/or as values determined by employing one or more sensor devices.

In various exemplary embodiments, the user 330 may be asked or provide information on how often he has already dyed his hair, bleached it, straightened it with a hair straightener, treated it with a permanent wave and/or with a care product (if applicable, which type of product) in order to determine the degree of damage.

In various exemplary embodiments, a near infrared sensor device and/or a fluorescence camera and/or a microphone comb and/or an interference reflection microscope may be used to determine the degree of damage, if necessary using suitable software (e.g. app).

In various exemplary embodiments the degree of graying, e.g. as a numerical value, may be provided by user 330 and/or determined by employing a sensor, e.g. by employing the provided photograph 332 or a photograph taken especially for this purpose.

In various exemplary embodiments, the method may be used to determine a skin color 330FG of user 330 (in 120).

In various exemplary embodiments, the determination of the skin color 330FG of user 330 may be carried out in an essentially known manner, for example by determining a skin area 330G in photograph 332, which represents user 332, and determining a skin color value 330FG, for example as an average value of color values found in the skin area 330FG.

In various exemplary embodiments a facial skin area 330G may be used to determine the skin color 330FG. This makes it possible to use a color 330FG of that skin area to determine a hair color matching the skin color, which is most often perceived together with the hair when looking at user 330. In various exemplary embodiments, e.g. if no facial skin area 330G is shown in the user's photograph, another skin area can be used to determine the skin color.

In various exemplary embodiments, a white balance may be carried out to determine realistic colors in a basically familiar way.

In various exemplary embodiments, the method may further include determining (in 130) a plurality of hair coloring results based on the original hair condition 330AFH, (334) of user 330 and a plurality of hair colorant compositions 340.

The plurality of hair colorant compositions 340 may comprise in various exemplary embodiments (e.g. all) hair colorant compositions available on the market, in various exemplary embodiments possibly no longer available hair colorant compositions, and/or a selection of the available hair colorant compositions, e.g. limited to certain chemical compositions or filtered in such a way that certain substances (e.g. allergenic for the user) are not contained, or the like. Alternatively, the plurality of hair colorant compositions 340 may contain a selection of the available hair colorant compositions, e.g. limited to a selected manufacturer or limited to a selected product line of a selected manufacturer.

The determination of the plurality of hair coloring results based on the original hair condition 330AFH can be carried out in various exemplary embodiments as described above, for example by using a predictive analysis method.

In various exemplary embodiments, the method may further include determining at least one hair coloring result 332C associated with skin color 330FG based on the plurality of hair coloring results and the skin color 330FG of the user (in 140).

In FIG. 3A and FIG. 3B, the two processes of determining the plurality of hair coloring results based on the original hair condition 330AFH and determining at least one hair coloring result 332C associated with skin color 330FG based on the plurality of hair coloring results and skin color 330FG are shown in combination, in such a way that, although 10 different hair colorant compositions 340 are shown as examples, of the corresponding 10 hair coloring results determined by way of example, only those four hair coloring results 332C1, 332C2, 332C3 and 332C4 that are assigned to the skin color 330FG of user 330 are shown.

In various exemplary embodiments, the determination of at least one hair coloring result 332C assigned to skin color 330FG may be carried out by using an assignment rule obtained by empirical studies.

To determine the assignment rule, in various exemplary embodiments it may be determined in empirical studies, which combination of hair and skin colors (parameterized in a color space, e.g. the L*a*b or the CIELAB color space) is considered suitable by viewers, and which combinations are not.

In various exemplary embodiments, the assignment rule determined from this may have at least one assigned hair color or at least one assigned hair color range for a plurality of skin color ranges.

When determining the at least one hair coloring result 332C assigned to skin color 330FG, the at least one assigned hair color or the at least one assigned hair color area can be determined in various exemplary embodiments by employing the assignment rule for the determined skin color 330FG, and as the at least one hair coloring result 332C assigned to skin color 330FG only that or those hair coloring result(s) can be determined, which is/are also a hair color assigned to skin color 330FG.

For example, in the case of very pale skin color 330FG, a deep black hair color may be considered inappropriate, so that the classification rule for very pale skin color 330FG does not include black hair color. Accordingly, the at least one hair coloring result 332C assigned to the skin color would not include black hair color, although in view of the original hair conditions and the plurality of hair colorant compositions provided, it would be possible to achieve black hair color in user 330.

In various exemplary embodiments, the method may also show a representation of at least one hair coloring result 332C associated with skin color 330FG (at 150).

In various exemplary embodiments, the representation may be carried out by employing a display and/or a printer and/or by another suitable device.

The hair coloring result 332C may be represented in various exemplary embodiments, as shown in FIG. 3A, in an essentially known manner, for example in such a way that in the photograph 332 of user 330 the hair area 330H is represented as hair area 330H colored in the color of the hair coloring result.

In a case where a plurality of photographs 332 or, for example, a video comprising individual frames is provided, a three-dimensional representation of user 330 with the hair area 330H dyed in the color of the hair coloring result can be generated.

In various exemplary embodiments, the user 330 may, as shown in FIG. 3B, select one (or, if applicable, several) of a plurality of hair coloring results 332C associated with the skin color 330FG (an example of a selection of hair coloring result 332C2).

For the selected hair coloring result a recommendation 350, e.g. a product recommendation 350, may be provided in various exemplary embodiments. In addition, user 330 may be provided in various exemplary embodiments, where the product is available.

In various exemplary embodiments, the user may be able to carry out a modification based on any of the at least one hair coloring result 332C assigned to the skin color, for example by employing a controller, a joystick, by wiping on a touch-sensitive screen, by employing a mouse, by employing voice input, etc.

After reaching a final state after modification (also called desired hair color), which the user 330 can display in the software (e.g. the app), the data processing device 200 can be used to determine from the plurality of hair coloring results that hair coloring result which shows a minimum color difference (e.g. in the L*a*b color space) to the desired hair color. Furthermore, a recommendation 350 can be provided to user 330.

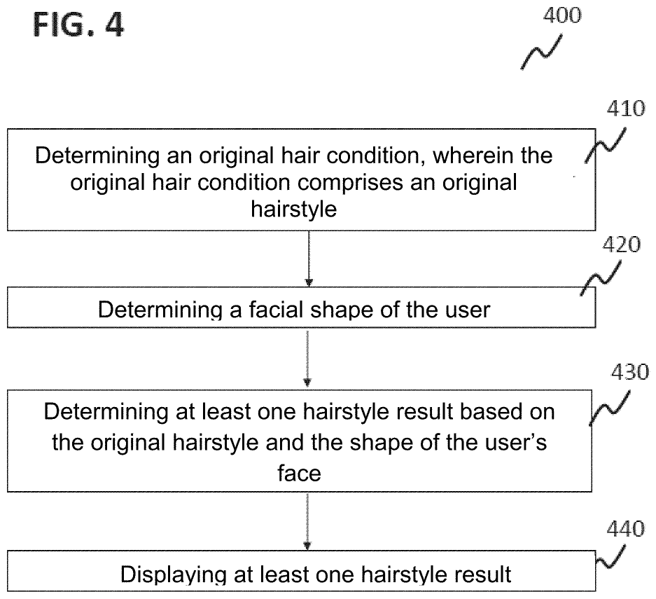

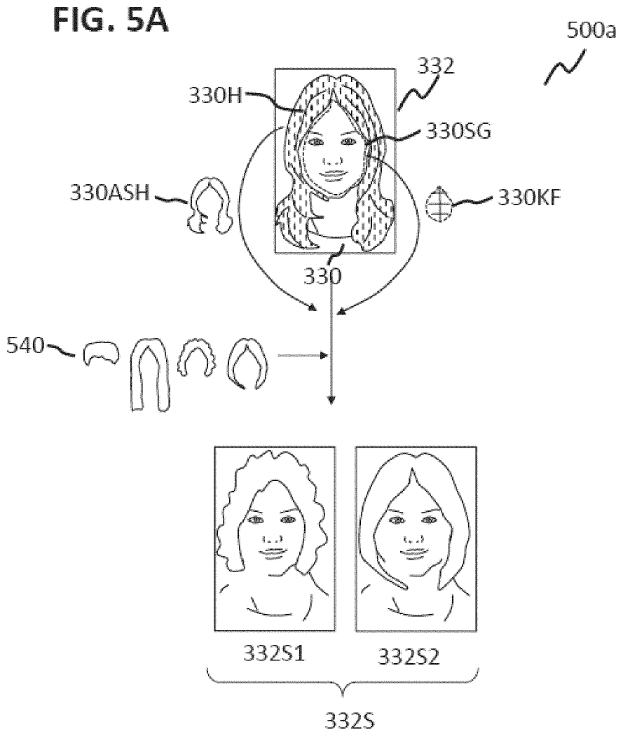

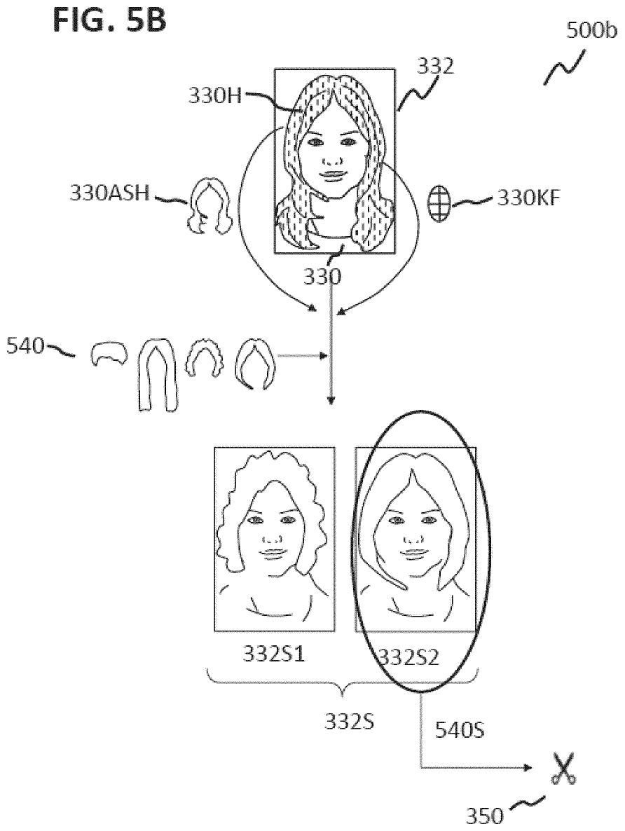

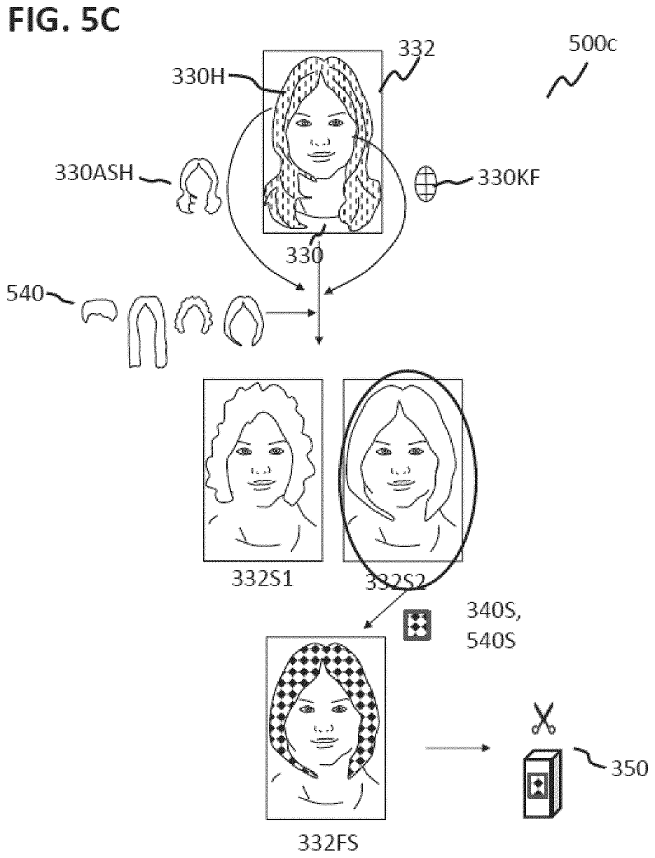

FIG. 4 shows a flowchart 400, which represents a method for computer-aided hair treatment consultation according to various exemplary embodiments, FIG. 2 shows the schematic representation of the data processing device 200 according to various exemplary embodiments, and FIG. 5A, 5B and 5C each show an illustration 500a, 500b or 500c of a method for computer-aided hair treatment consultation according to various exemplary embodiments.

The method may be carried out in various exemplary embodiments by employing the data processing device 200, which may be similar or identical to the data processing device 200 described above in connection with FIG. 3A and FIG. 3B, in so far as the installed software described above, e.g. the application (app), may be set up to perform both the method according to FIG. 1 (hair color determination) as well as the method according to FIG. 4 (hairstyle determination), or that the data processing device 200 may be set up to perform the method according to FIG. 4 as an alternative or in addition to the method according to FIG. 1 described above, for example by employing a specially installed software, e.g. an application (app).

In various exemplary embodiments, the data processing device 200 can be set up to carry out a combined method according to FIG. 1 and FIG. 4, i.e. to provide a hair treatment result, which provides a new hairstyle dyed in a new hair color.

In various exemplary embodiments, as shown in FIG. 5A, 5B and 5C, a digital photograph 332 may be provided, on which a user 330 is represented, for example as a portrait showing user 330 from the front. In particular, the photograph may show hair of user 330 (his hairstyle).

Photograph 332 may be provided as described above in connection with FIG. 3A and FIG. 3B.

In various exemplary embodiments an original hair condition of the user may be determined, whereby the original hair condition (as an original hair condition parameter) may show an original hairstyle 330ASH of user 330 (in 410).

In various exemplary embodiments the original hairstyle 330ASH may be determined on the basis of the provided photograph 332.

The original hairstyle 330ASH of user 330 in the provided photograph 332 may be determined in various exemplary embodiments in an essentially known manner, e.g. by identifying a hair area 330H in the photograph and determining an original hairstyle 330ASH (e.g. by identifying hair courses, hair lengths etc.).

In various exemplary embodiments, the method may further involve determining a facial shape 330KF of user 330 (in 120).

The determination of the facial shape 330KF of the user 330 may be done in various exemplary embodiments by determining a facial area 330SG in photograph 332, which represents user 332, and, if necessary, positions/sizes etc. of other areas of the face, e.g. the eyes, hairline, etc. On the basis of the determined areas, positions, sizes, etc., a parameterization of the face of user 330 can be carried out in various exemplary embodiments, e.g. on the basis of a size ratio of face width to face height, position of a hairline expressed as a proportionate distance of a total head height from the top of a head, etc.

In various exemplary embodiments, the method may further include determining at least one hairstyle result 332S based on the starting hairstyle 330ASH and the face shape 330KF of user 330 (in 430).

A plurality of hairstyles 540 may be provided for determining the hairstyle result 332S.

The determination of the at least one hairstyle result based on the original hairstyle 330ASH and the facial shape 330KF of the user can be carried out in various exemplary embodiments using exclusion criteria and an assignment rule.

The exclusion criteria may be designed in various exemplary embodiments in such a way that any hairstyle result 332S cannot be achieved from any hairstyle 332ASH. For example, hair extensions can be excluded, so that target hairstyles with a hair length greater than the original hairstyle 332ASH can be excluded using an exclusion criterion. Similarly, certain hair reshaping processes can be excluded, for example a straightening process, a haircut, or similar. The exclusion criteria can be designed in various exemplary embodiments as selectable by user 330.

In various exemplary embodiments, a classification rule obtained through empirical studies can be used to include the facial shape 330KF of user 330.

In various exemplary embodiments, empirical studies can be used to determine, which combination of face shape and hairstyle is considered suitable by viewers and which combinations are not.

In various exemplary embodiments, the assignment rule determined from this may include at least one assigned hairstyle for each of a plurality of face shapes or groups of face shapes.

When determining the at least one hairstyle result based on the original hairstyle 330 ASH and the facial shape 330KF of user 330, the at least one assigned hairstyle can be determined in various exemplary embodiments by employing the assignment rule for the determined facial shape 330KF, and as the at least one hairstyle result 332S only that or those hairstyle result(s) can be determined which simultaneously satisfy both the selection criteria and the assignment rule.

In the example of FIG. 5B, for example, a hairstyle 540 shown on the far left cannot be represented as hairstyle result 332S, because according to the classification rule for a face shape of user 330, which is judged to be broad, the hairstyle may be judged to be unsuitable.

In the example of FIG. 5B, for example, hairstyle 540, shown as the second hairstyle from the left, cannot be shown as hairstyle result 332S because, according to the selection criteria, hair extension, which would be necessary to achieve a corresponding target hairstyle, may be excluded.

In various exemplary embodiments, the method may further show a representation of at least one hairstyle result 332S (at 440).

In various exemplary embodiments the representation may be done by employing the display and/or a printer and/or by another suitable device.

The representation of the hair coloring result 332C may be carried out in various exemplary embodiments, as shown in FIG. 3A, in an essentially known manner, for example in such a way that in the photograph 332 of user 330 the hair area 330H is replaced by a hair area formed with the new hairstyle. Standard hairstyles (if necessary also three-dimensional) may be provided for replacement.

In the event that a number of photographs 332 or, for example, a video containing individual frames is provided, a three-dimensional representation of user 330 with the hairstyle result replacing his hair area can be provided.

In various exemplary embodiments, user 330, as shown in FIG. 5B, can select one (or, if applicable, several) of a plurality of hairstyle results 332S shown (exemplary shown is a selection of the hairstyle result 332S2).

For the selected hairstyle result a recommendation 350, e.g. a hair treatment recommendation 350 (here for example a recommendation that a haircut is required) can be provided in various exemplary embodiments. Product and/or hairdressing and/or care recommendations can be provided alternatively or additionally, e.g. that the new hairstyle requires a permanent wave (possibly with a product proposal and/or a proposal of one or more hairdressing salons), that a product should be used which gives the hair more volume, etc. In various exemplary embodiments a hairdresser appointment can be booked directly via the software/app. Alternatively, a hairdresser appointment can be booked via a separate software/app, such as Treatwell.

In addition, user 330 can be provided with various exemplary embodiments, where the product is available.

In various exemplary embodiments, as shown in FIG. 5C, the methods described in connection with FIG. 1 and in connection with FIG. 4 can be used in combination to provide a hairstyle result 332FS dyed in a new hair color.

The individual processes can be applied as described in connection with the respective methods, either as shown in FIG. 5C, by first determining a hairstyle result 332S, for which a hair color is then determined according to different exemplary embodiments, or vice versa.

Accordingly, recommendations 350 can refer both to achieving the hair color and to achieving the desired hairstyle.

In various exemplary embodiments, a hairstyle 540 provided by the user 330 may be used instead of a number of hairstyles when determining the hairstyle result. The hairstyle 540 can be provided for the data processing device 200 by user 330, for example, as a digital photograph and processed by the software into a possible hairstyle (which can be inserted into the photograph of user 330).

In various exemplary embodiments, the selection criteria can then be chosen so that the hairstyle provided is the only possible hairstyle.

A similar process can be used for a number of hairstyles provided by user 330.

Further advantageous configurations of the method result from the description of the device and vice versa.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. Method for computer-aided hair treatment consultation, comprising:
providing at least one digital image of a user in which both hair and skin of the user are shown;
determining an original hair condition of a user, wherein the original hair condition comprises an original hair color of the user;
determining a skin color of the user;
determining a plurality of hair coloring results based on the original hair condition of the user and a plurality of hair colorant compositions;
determining at least one hair coloring result associated with the skin color based on the plurality of hair coloring results and the skin color of the user; and
output of at least one hair coloring result assigned to the skin color.

2. Method according to claim 1,
wherein the original hair condition further comprises a degree of hair damage and/or a degree of graying.

3. Method according to claim 1,
wherein the determination of a plurality of hair coloring results based on the original hair condition of the user and a plurality of hair colorant compositions is performed by employing predictive analytics.

4. Method according to claim 1,
wherein the determination of at least one hair coloring result assigned to the skin color is carried out using an assignment rule obtained by empirical studies.

5. Method according to claim 1, further comprising:
modifying the hair coloring result by the user to a desired hair color; and
determining the hair colorant composition from the plurality of available hair colorant compositions that has the smallest color difference compared with the desired hair color.

6. Method for computer-aided hair treatment consultation, comprising:
providing at least one digital photograph of a user in which both hair and skin of the user are depicted;
determining an original hair condition, wherein the original hair condition comprises an initial hairstyle;
determining a facial shape of the user;
determining at least one hairstyle result based on the original hairstyle and the facial shape of the user; and
output of at least one hairstyle result.

7. Method according to claim 6,
wherein the determined hairstyle result has one of a plurality of hairstyles obtainable by reshaping the hair.

8. Method according to claim 6,
wherein the determined hairstyle result has one of a plurality of hairstyles achievable by reshaping and/or by shortening the hair.

9. Method according to claim 6,
whereby the output of the hairstyle result is in the desired hair color or the determined hair coloring result.

10. Method according to claim 1, further comprising:
providing a desired hairstyle by the user;
determining a hairstyle most similar to the desired hairstyle from a plurality of achievable hairstyles; and
display of the most similar hairstyle in the hair color of the assigned hair coloring result.

11. Method according to claim 1, further comprising:
providing product and/or hair treatment information based on the determined hair coloring result and/or on the determined hairstyle result.

12. Method according to claim 11, further comprising:
enabling the user to order a recommended product online and/or indicating where the recommended product is available.

13. Data processing device for carrying out a method for computer-aided hair treatment consultation,
wherein the data processing device is configured to perform the method according to claim 1.

14. Method according to claim 2,
wherein the determination of a plurality of hair coloring results based on the original hair condition of the user and a plurality of hair colorant compositions is performed by employing predictive analytics.

15. Method according to claim 2,
wherein the determination of at least one hair coloring result assigned to the skin color is carried out using an assignment rule obtained by empirical studies.
